(19) United States
(12) Patent Application Publication
(10) Pub. No.: US 2015/0033279 A1
(43) Pub. Date: Jan. 29, 2015

(54) TRANSMITTING APPARATUS, RECEIVING APPARATUS AND CONTROL METHODS THEREOF

(71) Applicant: SAMSUNG ELECTRONICS CO., LTD., Suwon-si (KR)

(72) Inventors: Sung-ryul YUN, Suwon-si (KR); Young-ho OH, Suwon-si (KR)

(73) Assignee: SAMSUNG ELECTRONICS CO., LTD., Suwon-si (KR)

(21) Appl. No.: 14/273,736

(22) Filed: May 9, 2014

(30) Foreign Application Priority Data
Jul. 26, 2013 (KR) 10-2013-0088856

(51) Int. Cl. H04N 21/61

(52) U.S. Cl. CPC H04N 21/6112
USPC 725/118; 725/131

(57) ABSTRACT

A transmitting apparatus is provided. The transmitting apparatus includes a frame generator configured to generate a frame by mapping data included in an input stream to at least one signal processing path, an information inserter configured to insert signaling information including a configurable field and a dynamic field into a signaling area of the frame, and a transmitter configured to transmit the frame in which the signaling information is inserted. The dynamic field selectively includes only information about a number of data blocks among information about the data mapped to the at least one signal processing path. Therefore, transmission efficiency of the transmitting apparatus is increased.

### CROSS-REFERENCE TO RELATED APPLICATION

This application claims priority from Korean Patent Application No. 10-2013-0088856, filed on Jul. 26, 2013, in the Korean Intellectual Property Office, the disclosure of which is incorporated herein by reference in its entirety.

### BACKGROUND

1. Field

Apparatuses and methods consistent with exemplary embodiments relate to transmitting data by mapping the data to at least one signal processing path.

2. Description of the Related Art

In recent years, high quality broadcasting communications have been achieved due to multifunction and broadband services. In particular, with the development of electronic technologies, portable broadcasting apparatuses such as high-definition digital televisions (HDTVs) or high-end smart phones have been widely distributed, and thus demands for various reception methods with respect to broadcasting services, and various service supports are growing.

According to these demands, a broadcasting communication standard such as Digital Video Broadcasting the Second Generation Terrestrial (DVB-T2) standard has been developed as one example. The DVB-T2 is an improved version of DVB-T which is a standard adopted in 35 countries or more in the world including Europe. A DVB-T2 system increases a transmission capacity and realizes a high bandwidth efficiency by applying the latest technology such as a Low-Density Parity Check (LDPC) code and a 256 quadrature amplitude modulation (QAM) method, and thus various services with a high quality like HDTVs may be provided in a limited band.

The DVB-T2 system may enable to carry data in a broadcast stream in various methods to provide various services. In order for receiving apparatuses to accurately identify a location of the data in the broadcast stream, transmitting apparatuses have to transmit a lot of information about a location, a size and the like related to the data together with the data. Therefore, the transmission efficiency is degraded since a lot of data-related information has to be transmitted.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a transmitting apparatus, a receiving apparatus, and control methods thereof, capable of improving transmission efficiency through reduction in transmitted information.

According to an aspect of an exemplary embodiment, there is provided a transmitting apparatus. The transmitting apparatus may include: a frame generator configured to generate a frame by mapping data included in an input stream to at least one signal processing path; an information inserter configured to insert signaling information including a configurable field and a dynamic field into a signaling area of the frame; and a transmitter configured to transmit the frame in which the signaling information is inserted. The dynamic field may selectively include only information about a number of data blocks among information about the data mapped to the at least one signal processing path.

The information about the number of data blocks may be included in the configurable field or the dynamic field.

The signaling information may include pre-signaling information and post-signaling information, and the configurable field and the dynamic field may be included in the post-signaling information.

The transmitting apparatus may be implemented as a DVB-T2 transmission system, and the frame may be implemented as a T2 frame.

According to an aspect of an exemplary embodiment, there is provided a receiving apparatus. The receiving apparatus may include: a receiver configured to receive a frame which comprises data mapped to at least one signal processing path, and signaling information having a configurable field and a dynamic field; and a signal processor configured to perform signal processing on the frame. The dynamic field may selectively include only information about a number of data blocks among information about the data mapped to the at least one signal processing path.

The information about the number of data blocks may be included in the configurable field or the dynamic field.

The signaling information may include pre-signaling information and post-signaling information, and the configurable field and the dynamic field may be included in the post-signaling information.

The signal processor may calculate a size of a signaling area of the frame based on the signaling information, and calculate a start location of data mapped to a first signal processing path among the data mapped to the at least one signal processing path based on the calculated size of the signaling area.

The signal processor may calculate a start location of data mapped to an n-th signal processing path based on a start location of data mapped to an (n−1)-th signal processing path among the at least one signal processing path.

The configurable field may include identification (ID) information about the data mapped to the at least one signal processing path, data code rate information, data modulation information, and data forward error correction (FEC) type information.

According to an aspect of an exemplary embodiment, there is provided a control method of a transmitting apparatus. The control method may include: generating a frame by mapping data included in an input stream to at least one signal processing path; inserting signaling information including a configurable field and a dynamic field into a signaling area of the frame; and transmitting the frame in which the signaling information is inserted. The dynamic field may selectively include only information about a number of data blocks among information about the data mapped to the at least one signal processing path.

The information for the number of data blocks may be included in the configurable field or the dynamic field.

The signaling information may include pre-signaling information and post-signaling information, and the configurable field and the dynamic field may be included in the post-signaling information.

The transmitting apparatus may be implemented as a DVB-T2 transmission system, and the frame may be implemented as a T2 frame.

According to an aspect of an exemplary embodiment, there is provided a control method of a receiving apparatus. The control method may include: receiving a frame which includes data mapped to at least one signal processing path, and signaling information having a configurable field and a dynamic field; and performing signal processing on the frame. The dynamic field may selectively include only information about a number of data blocks among information about the data mapped to the at least one signal processing path.

The information about the number of data blocks may be included in the configurable field or the dynamic field.

The signaling information may include pre-signaling information and post-signaling information, and the configurable field and the dynamic field may be included in the post-signaling information.

The performing signal processing may include calculating a size of a signaling area of the frame based on the signaling information, and calculating a start location of data mapped to a first signal processing path among the data mapped to the at least one signal processing path based on the calculated size of the signaling area.

The performing signal processing may include calculating a start location of data mapped to an n-th signal processing path based on a start location of data mapped to an (n−1)-th signal processing path among the at least one signal processing path.

The configurable field may include identification (ID) information about the data mapped to the at least one signal processing path, data code rate information, data modulation information, and data FEC type information.

According to the above-described various exemplary embodiments, transmission efficiency is improved.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a block diagrams illustrating configurations of a transmitting apparatus, according to an exemplary embodiment;

FIG. 2 is a block diagram illustrating a configuration of a DVB-T2 system at a transmission side, according to an exemplary embodiment;

FIG. 3 is a block diagram illustrating a configuration for generating signaling information, according to an exemplary embodiment;

FIG. 4 is a view illustrating a unit structure of a transmission frame, according to an exemplary embodiment;

FIG. 5 is a view illustrating a transmitted frame structure, according to an exemplary embodiment;

FIG. 6 is a view illustrating a configurable field and a dynamic field, according to an exemplary embodiment;

FIG. 7 is a block diagram illustrating a configuration of a receiving apparatus, according to an exemplary embodiment;

FIG. 8 is a detailed block diagram illustrating a signal processor, according to an exemplary embodiment;

FIG. 9 is a view illustrating a process of calculating a start location of data mapped to a first signal processing path, according to an exemplary embodiment;

FIGS. 10A and 10B are views illustrating a process of calculating a start location of data mapped to a signal processing path, according to an exemplary embodiment;

FIG. 11 is a flowchart illustrating a control method of a transmitting apparatus, according to an exemplary embodiment; and

FIG. 12 is a flowchart illustrating a control method of a receiving apparatus, according to an exemplary embodiment.

### DETAILED DESCRIPTION OF THE EXEMPLARY EMBODIMENTS

Hereinafter, exemplary embodiments will be described in more detail with reference to the accompanying drawings.

In the following description, the same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

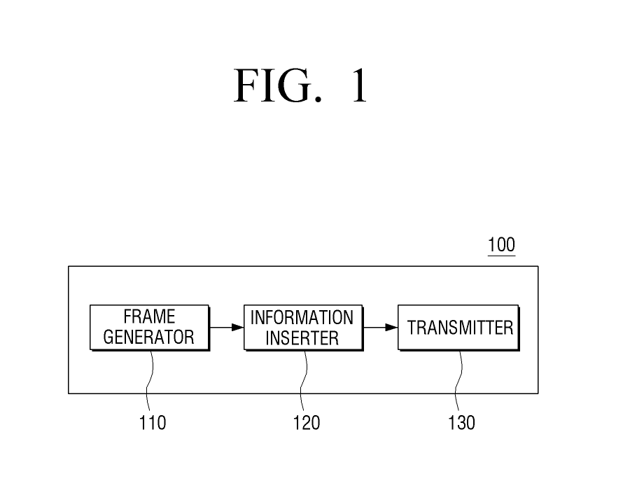

FIG. 1 is a block diagram illustrating configurations of a transmitting apparatus according to an exemplary embodiment. Referring to FIG. 1, a transmitting apparatus 100 includes a frame generator 110, an information inserter 120, and a transmitter 130.

The frame generator 110 generates a frame by mapping data included in an input stream to at least one signal processing path. According to an exemplary embodiment, a DVB-T2 system applies a physical layer pipe (PLP) concept to provide various broadcasting services through one channel. Here, these broadcasting services have different modulation methods, channel encoding rates, and time and cell interleaving lengths.

Here, the PLP means a signal processing path independently processed. That is, services (for example, video, extended video, audio, data stream, or the like) may be received and transmitted through a plurality of radio frequency (RF) channels, and the PLP is a path through which each of these services is transmitted or a stream including data transmitted through the path. The PLP may be located in slots distributed on the plurality of RF channels with a time interval or may be distributed on one RF channel with a time interval. That is, one PLP may be distributed on one RF channel or a plurality of RF channels with a time interval.

The PLP structure may be configured of an input node A providing one PLP and/or an input node B providing a plurality of PLPs. In particular, when the input mode B is supported, a robust specific service may be provided, and since one stream is distributed and transmitted, a time interleaving length is increased to obtain a time diversity gain. Further, when only a specific stream is received, a receiver of the specific stream may turn off power during a remaining period of time and be used with low power, and thus, the receiver may be suitable for portability and provision for mobile broadcasting services.

Here, the time diversity is technology in which when the same signal is transmitted with a certain time interval several times at a transmission side to alleviate deterioration of a transmission quality in a mobile communication transmission line, a reception signal is synthesized to obtain a good transmission quality at a receiver of the signal.

Further, information which may be commonly transmitted to a plurality of PLPs is included in one PLP and transmitted to increase transmission efficiency, and the PLP may be referred to as a common PLP. The remaining PLPs other than common PLP may be used for data transmission, and these PLPs may be referred to data PLPs.

That is, the frame generator 110 generates a frame by mapping data included in an input stream to at least one signal processing path, and performs signal processing according to each path. For example, the signal processing may include at least one process among input stream synchronization, delay compensation, null packet deletion, cyclic redundancy clock (CRC) encoding, header insertion, coding, interleaving, and modulation. A frame which is processed in each signal processing path may be generated as one transmission frame together with signaling information, and the generated transmission frame is transmitted to a receiving apparatus (not shown).

The information inserter 120 inserts the signaling information including a configurable field and a dynamic field into a signaling area of the frame generated by the frame generator 110. The signaling area corresponds to a P2 symbol for frame synchronization. The signaling area is added to a start portion of the frame to generate a transmission frame. In an exemplary embodiment, in the DVB-T2 system, one unit of the transmission frame may include a P1 symbol and the signaling area to constitute a T2 frame. The signaling area may be a P2 symbol which transmits a layer 1 (L1) signal.

The P2 symbol may be divided into a pre-signaling information area and a post-signaling information area. The post-signaling information area may include the configurable field and the dynamic field. The signaling area will be described later.

The transmitter 130 transmits the transmission stream in which the signaling information is inserted. Specifically, the transmitting apparatus 100 may transmit service data together with signaling information including location and size information of the service data to the receiver (not shown).

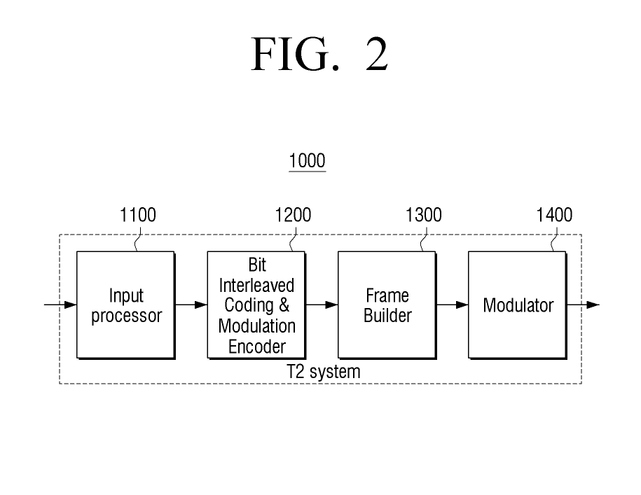

FIG. 2 is a block diagram illustrating a configuration of a transmission-side DVB-T2 system.

Referring to FIG. 2, a DVB-T2 system 1000 may include an input processor 1100, a bit interleaved coding and modulation (BICM) encoder 1200, a frame builder 1300, and a modulator 1400.

The components of the DVB-T2 transmission system 1000 will be schematically described considering that these components comply with the DVB-T2 standard. Refer to “Digital Video Broadcasting (DVB); Frame structure channel coding and modulation for a second generation digital terrestrial television broadcasting system (DVB-T2)”, which is ETSI EN 302 755 v1.3.1 (2012-4), for details.

The input processor 1100 generates a baseband (BB) frame from an input stream with respect to data to be serviced. Here, the input stream may be an MPEG-2 transport stream (TS), a generic stream (GS), or the like.

The BICM encoder 1200 determines a forward error correction (FEC) coding rate and a constellation order according to an area, that is, a frame, through which the data to be serviced is to be transmitted. The frame is a fixed physical layer (PHY) frame or a mobile PHY frame to perform encoding. The BICM encoder 1200 may perform encoding on signaling information about the data to be serviced.

The frame builder 1300 and the modulator 1400 may form a frame by determining a BICM-orthogonal frequency division multiplexing (BICM-OFDM) parameter for a signaling area, which includes the signaling information, and an OFDM parameter for the frame through which the data to be serviced is to be transmitted, and generates the frame by adding a synchronization area. The frame builder 1300 and the modulator 1400 may perform modulation for modulating the generated frame to an RF signal, and transmit the RF signal to a receiver.

At this time, information indicating whether the received frame is a mobile frame or a fixed frame is inserted into the synchronization area. When the OFDM parameter of the signaling area or the data area for each frame is not previously determined, the information indicating the received frame, that is, the OFDM parameter for the signaling area and the data area are stored in the synchronization area and transmitted.

The frame generation described in FIG. 1 may be performed in the input processor 1100, and the information insertion described in FIG. 1 may be performed in the frame builder 1200.

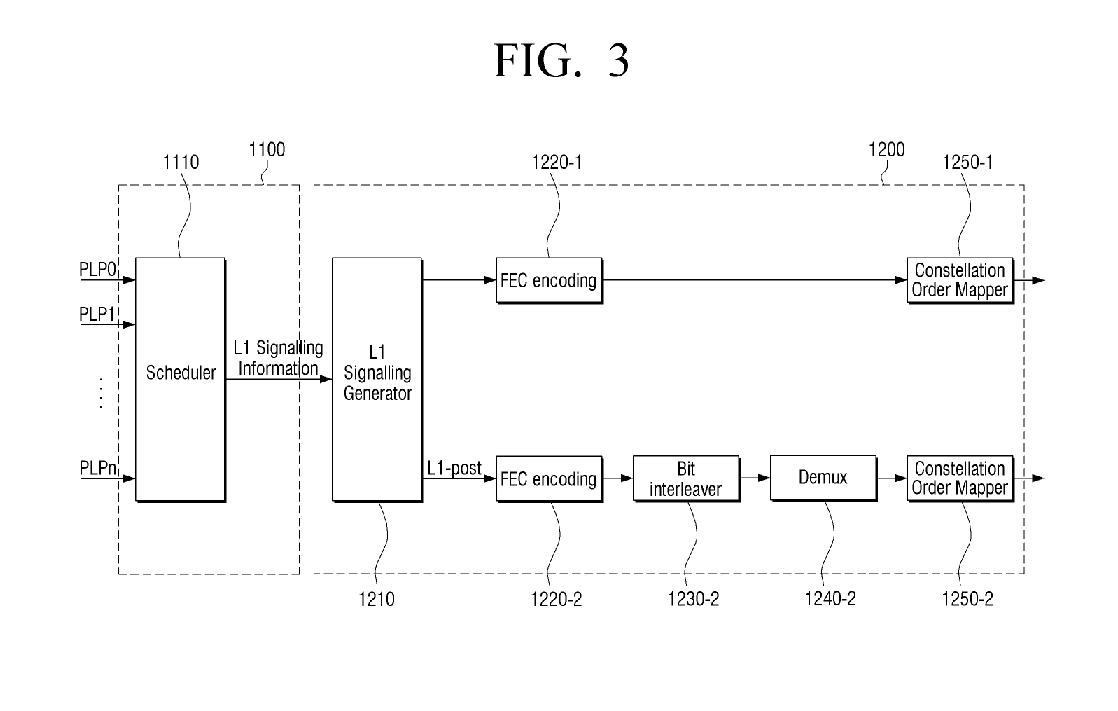

FIG. 3 is a block diagram illustrating a configuration for generating signaling information according to an exemplary embodiment.

Referring to FIG. 3, the input processor 1100 and the BICM encoder 1200 of the DVB-T2 system 1000 in FIG. 2 are illustrated. The input processor 1100 may include a scheduler. The BICM encoder 1200 may include an L1 signaling generator 1210, FEC encoders 1220-1 and 1220-2, a bit interleaver 1230-2, a demultiplexer 1240-2, and constellation order mapper 1250-1 and 1250-2. The BICM encoder 1200 may further include a time interleaver (not shown). The L1 signaling generator 1210 may be included in the input processor 1100 instead of the BICM encoder 1200.

N pieces of service data are mapped to PLP0 to PLPn, respectively. The scheduler 1110 determines a location, modulation, a code rate, or the like of each PLP to map a plurality of PLPs to a T2 physical layer. That is, the scheduler 1110 generates L1 signaling information, and transmits this L1 signaling information to the BICM encoder 1200. The L1 signaling information includes L1 pre-signaling information and L1 post-signaling information. In some cases, the scheduler 1110 may output dynamic field information among the L1 post signaling information of a current frame to the frame builder 1300 shown in FIG. 2.

The L1 signaling generator 1210 distinguishes the L1 pre-signaling information from the L1 post-signaling information when outputting the L1 signaling information. Each of the FEC encoders 1220-1 and 1220-2 performs FEC encoding including shortening and puncturing with respect to the L1 pre-signaling information and the L1 post-signaling information, respectively. The bit interleaver 1230-2 may perform interleaving on the encoded L1 post-signaling information in bit units. The demultiplexer 1240-2 controls an order of bits constituting a cell to control robustness of the bits, and outputs the cell including the bits. Each of two constellation order mappers 1250-1 and 1250-2 maps cells of the L1 pre-signaling information and the L1 post-post signaling information to the constellation order. The L1 pre-signaling information and the L1 post-signaling information processed through the above-described process are output to the frame builder 1230.

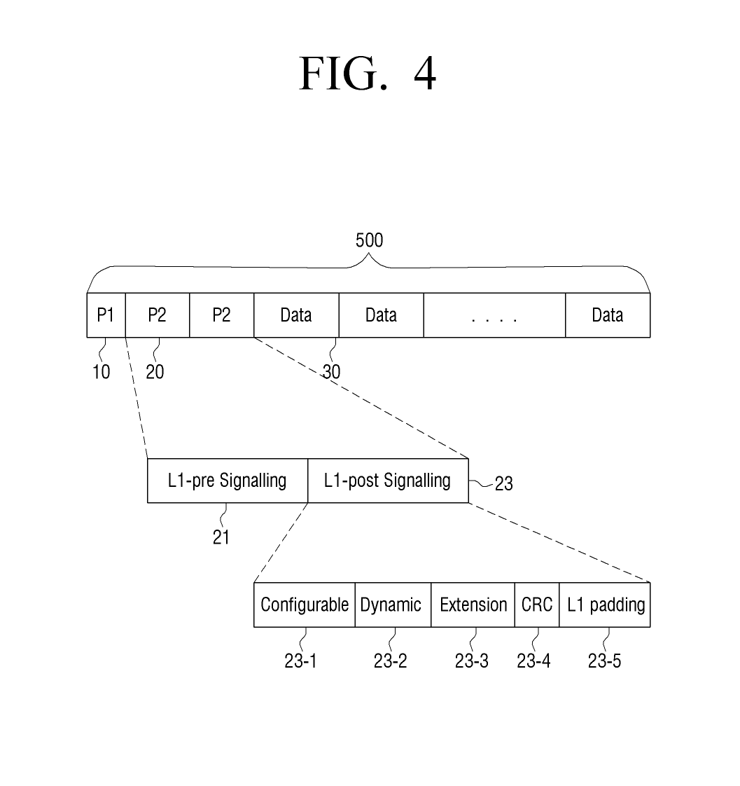

FIG. 4 is a view illustrating a structure of a transmission frame according to an exemplary embodiment.

Referring to FIG. 4, one transmission frame unit called a T2 frame 500 in the DVB-T2 system of FIGS. 1 and 2 is illustrated. The T2 frame 500 may include a P1 symbol 10 configured to indicate a start location of a frame, a P2 symbol 20 configured to transmit an L1 signal, and data symbols 30 configured to transmit data.

The P1 symbol 10 is located in a first location of the T2 frame 500, and may be used to detect a starting point of the T2 frame 500. The P1 symbol 10 may transmit 7-bit information.

The P2 symbol is located next to the P1 symbol 10 of the T2 frame 500. A plurality of P2 symbols 20 may be included in the T2 frame 500 according to a fast Fourier transform (FFT) size. The number of P2 symbols 20 included according to the FFT size is listed in Table 1.

TABLE 1

| FFT Size | Number of P2 Symbols |
|---|---|
| 1K | 16 |
| 2K | 8 |
| 4K | 4 |
| 8K | 2 |
| 16K | 1 |
| 32K | 1 |

The number of data cells usable in one P2 symbol 20 according to the FFT size is listed in Table 2.

TABLE 2

Number of Cells

| FFT Size | SISO | MISO |
|---|---|---|
| 1K | 558 | 546 |
| 2K | 1118 | 1098 |
| 4K | 2236 | 2198 |
| 8K | 4472 | 4398 |
| 16K | 8944 | 8814 |
| 32K | 22432 | 17612 |

A single input single output (SISO) method uses one transmission antenna and one reception antenna to transmit and receive a broadcasting signal. A multiple input single output (MISO) method receives a broadcasting signal using a plurality of transmission antennas and one reception antenna without performance loss.

The P2 symbol 20 includes L1 pre-signaling information 21 and L1 post-signaling information 23. The L1-pre signaling information 21 provides a basic transmission parameter including parameters required to receive and decode the L1 post-signaling information 23.

The L1 post-signaling information 23 includes a configurable field 23-1 and a dynamic field 23-2. Further, the L1 post-signaling information 23 may selectively include an extension field 23-3. The L1 post-signaling information 23 may include a CRC field 23-4, and if necessary, the L1 post-signaling information 23 may further include a L1 padding field 23-5.

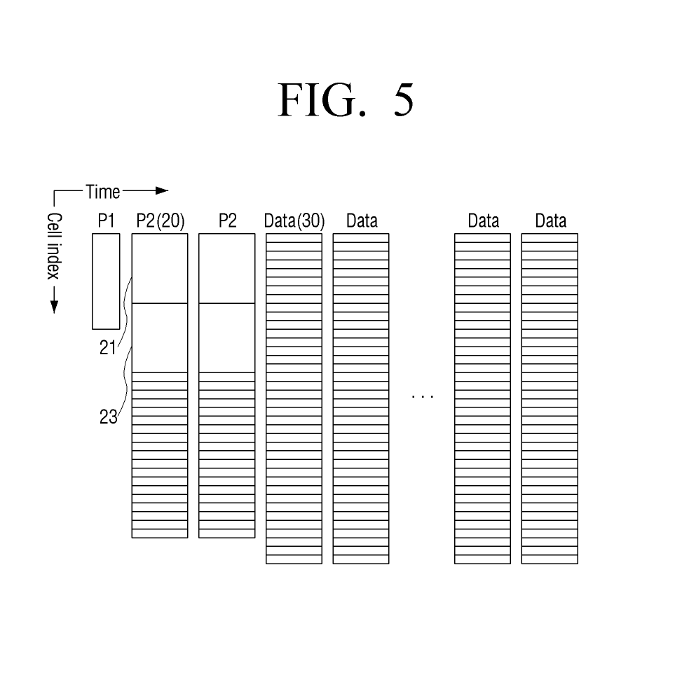

FIG. 5 is a view illustrating a transmitted frame structure according to an exemplary embodiment.

Referring to FIG. 5, one T2 frame which is a unit frame of a transmission frame is illustrated. The T2 frame includes a P1 symbol 10, two P2 symbols 20, and a plurality of data symbols 30 on a time axis. As described above, a plurality of P2 symbols may exist according to the FFT size. Unlike a system complying the DVB_T standard, as illustrated in the PLP conceptual view of FIG. 1A, the DVB-T2 system of FIGS. 1 and 2 may apply, to one broadcasting channel, the PLP concept capable of providing various broadcast services having modulation methods, channel encoding rates, time and cell interleaving lengths, or the like different from one another. Therefore, each of the data symbols 30 may include at least one PLP according to a kind of service, or the like. The P2 symbol 20 may include an area for the pre-signaling information 21 and an area for the post-signaling information 23.

According to an exemplary embodiment, the T2 frame is modulated with an OFDM modulation method, and as illustrated in FIG. 5, a plurality of cells may be transmitted at the same time. That is, one stream is distributed and transmitted in a manner to increase a time interleaving length and to obtain a time diversity gain.

The post-signaling information 23 of the P2 symbol 20 includes information for receiving and decoding the data symbol 30. As described above, the data symbol 30 may include a plurality of PLPs, and an amount of information included in the P2 symbol 20 is increased as the number of PLPs included in the data symbol 30 is increased. Hereinafter, information included in the configurable field 23-1 and the dynamic field 23-2 among the post-signaling information 23 will be described.

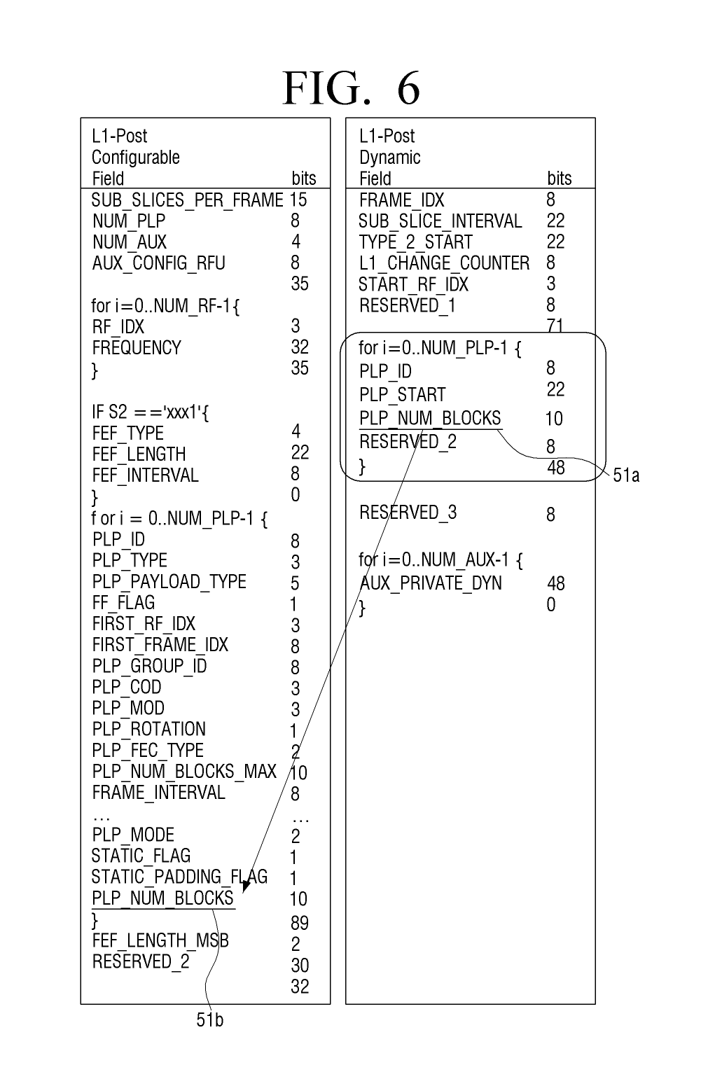

FIG. 6 is a view illustrating a configurable field and a dynamic field according to an exemplary embodiment.

Referring to FIG. 6, a field value defined in the DVB-T2 standard in the related art is illustrated. That is, the configurable field 23-1 includes data identifier (ID) information PLP_ID, data code rate information PLP_COD, data modulation information PLP_MOD, and data FEC type information PLP_FEC_TYPE. The dynamic field 23-2 includes data ID information PLP_ID, data start location information PLP_START, and information for the number of data blocks PLP_NUM_BLOCKS.

The data ID information PLP_ID has an 8-bit size, and is information for identifying PLPs included in the T2 frame. The data code rate information PLP_COD has a 3-bit size, and is information for identifying a code rate used in an associated PLP. The data modulation information PLP_MOD has a 3-bit size, and is information for identifying a modulation method used in an associated PLP. The data FEC type information PLP_FEC_TYPE has a 2-bit size, and is information for identifying an FEC type used in an associated PLP.

The data start location information PLP_START has a 22-bit size, and is information for indicating a start location of each PLP. The information for the number of data blocks PLP_NUM_PLOCKS has a 10-bit size, and is information for indicating the number of FEC blocks.

That is, in the related art, data information in the dynamic field 23-2 includes the 8-bit data ID information PLP_ID, the 22-bit data start location information PLP_START, the 10-bit information for the number of data blocks PLP_NUM_PLOCKS, and 8-bit reserved area, and thus, the data information in the dynamic field 23-2 may be set at a total 48-bit size. A receiving apparatus (not shown) detects PLPs in the received T2 frame and performs decoding on the PLPs by repeatedly detecting the data information for each of the PLPs.

However, in the exemplary embodiment, 38 bits of the 8-bit data ID information PLP_ID, the 22-bit data start location information PLP_START, and 8-bit reserved area among the data information in the dynamic field 23-2 are deleted. Alternatively, part of the 8-bit data ID information PLP_ID, the 22-bit data start location information PLP_START, and 8-bit reserved area among the data information in the dynamic field 23-2 may be deleted. Deleting part of the data information in a transmitting apparatus may be performed in a way not to detect corresponding information from the beginning or in a way to detect the corresponding information and neglect the detected information.

As illustrated in FIG. 6, the dynamic field 23-2 may include information about the number of data blocks PLP_NUM_BLOCKS (see 51a), or the configurable field 23-1 may include information about the number of data blocks PLO_NUM_BLOCKS (see 51b). That is, the information about the number of data blocks PLP_NUM_BLOCKS may be included in the configurable field 23-1 or the dynamic field 23-2. A field in which the information about the number of data blocks PLP_NUM_BLOCKS is to be included may be determined in advance, and the transmitting apparatus and the receiving apparatus may be designed according to a preset protocol.

According to the preset protocol, the transmitting apparatus may include only the information about the number of data blocks PLP_NUM_BLOCKS among the data information in any one of the configurable field 23-1 and the dynamic field 23-2, and transmit the frame including the information about the number of data blocks PLP_NUM_BLOCKS. The receiving apparatus receives the frame transmitted from the transmitting apparatus according to the preset protocol.

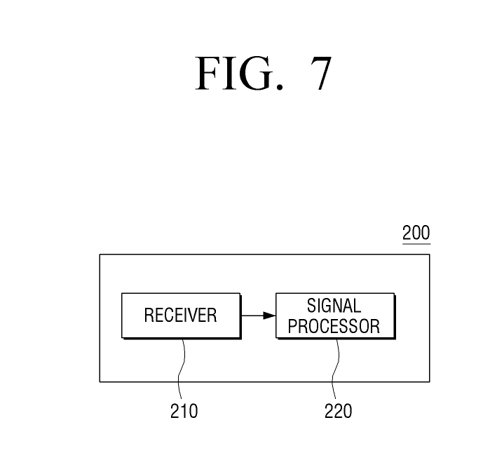

FIG. 7 is a block diagram illustrating a configuration of a receiving apparatus according to an exemplary embodiment.

Referring to FIG. 7, a receiving apparatus 200 includes a receiver 210 and a signal processor 220. The receiver 210 receives a frame including signaling information having a configurable field and a dynamic field, and data mapped to at least one signal processing path. As described above, the receiving apparatus may receive a frame in which only the information about the number of data blocks PLP_NUM_BLOCKS among the data information is included in any one of the configurable field and the dynamic field. The signaling information includes pre-signaling information and post-signaling information. The post-signaling information includes the configurable field and the dynamic field. The configurable field includes data ID information PLP_ID, data code rate information PLP_COD, data modulation information PLP_MOD, and data FEC type information PLP_FEC_TYPE.

The signal processor 220 performs signal processing on the received frame. For example, the signal processor performs a process including demodulation, frame builder, BICM decoding, and input de-processing.

The signal processor 220 may calculate a size of a signaling area of the frame based on the signaling information, and calculate a start location of data mapped to a first signal processing path based on the calculated size of the signaling area. The signal processor 220 may calculate a start location of data mapped to a current signal processing path based on a start location of data mapped to an immediately previous signal processing path, the information of the number of data blocks, the data modulation information, and the data FEC type information. Calculation of the start location of the mapping data will be described in detail later.

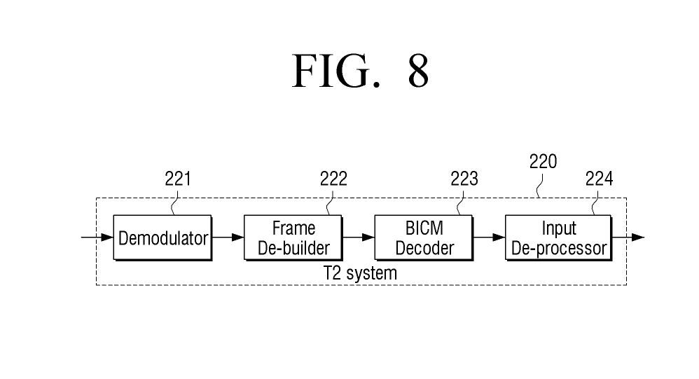

FIG. 8 is a detailed block diagram illustrating a signal processor of a receiving apparatus according to an exemplary embodiment. The signal processor of FIG. 8 corresponds to the signal processor 220 which is illustrated in FIG. 7 and is implemented in a DVB-T2 receiving system, according to an exemplary embodiment.

The signal processor 220 includes a demodulator 221, a frame de-builder 222, a BICM decoder 223, and an input de-processor 224.

The demodulator 221 performs synchronization detection by performing demodulation according to OFDM parameters from a received RF signal, and when the synchronization is detected, the demodulator 221 recognizes whether a mobile frame is received or a fixed frame is received from information stored in a synchronization area.

When the OFDM parameters for the signaling area and the data area are not previously determined, the demodulator 221 may perform demodulation on the signaling area and the data area, which are next to the synchronization area, by acquiring the OFDM parameters for the signaling area and the data area stored in the synchronization area.

The frame de-builder 222 inputs data demodulated with respect to the signaling area to the BICM decoder 223.

The BICM decoder 223 performs demodulation on input data. The BICM decoder 223 may perform BICM demodulation by acquiring parameters such as an FEC method or a modulation method with respect to data stored in each data area using the signaling information. The BICM decoder 223 may calculate a start location of data based on data information included in the configurable field and the dynamic field.

The input de-processor 224 may process a BB frame received from the BICM decoder 223 to generate data to be serviced.

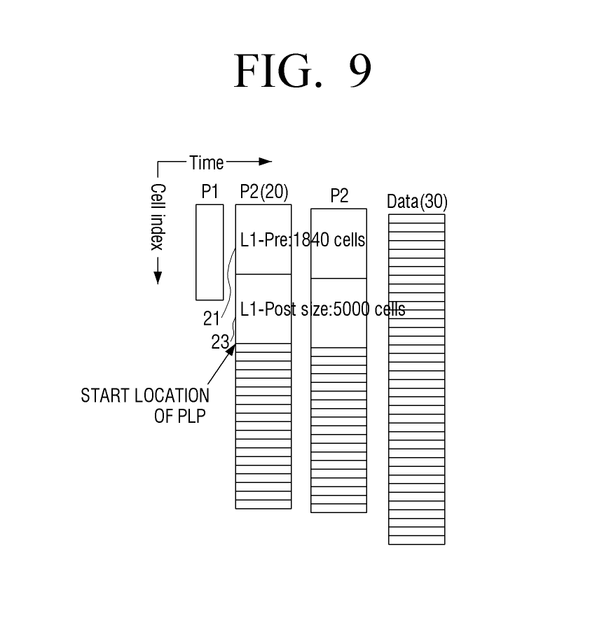

FIG. 9 is a view illustrating a process of calculating a start location of data mapped to a first signal processing path according to an exemplary embodiment.

FIG. 9 illustrates one T2 frame. The T2 frame includes a P1 symbol 10, a P2 symbol 20, and a data symbol 30. The P2 symbol 20 includes pre-signaling information 21 and post-signaling information 23, and the data symbol 30 includes a plurality of PLPs.

A first PLP is located next to the post-signaling information 23, and thus a start location of the first PLP may be calculated by calculating sizes of the pre-signaling information 21 and the post-signaling information 23.

In an embodiment, the pre-signaling information 21 is fixed to 200 bits, and an encoding bit of 1840 bits is generated when the 200 bits are encoded through low density parity check (LDPC). When the 200 bits are modulated through a binary phase shift keying (BPSK) method, 1840 symbols are generated since one bit is represented as one symbol, and the 1840 symbols are mapped to generate 1840 cells. Therefore, a size of the pre-signaling information 23 becomes 1840 cells.

The post-signaling information 23 may be seen from an item of a post size L1_POST_SIZE among the pre-signaling information 21. The item of the post size L1_POST_SIZE has an 18-bit size and indicates the number of OFDM cells. Therefore, the sizes of the pre-signaling information 21 and the post-signaling information 23 may be calculated by adding the 1840 cells and the item (for example, the number of cells represented by 18-bits) of the post size L1_POST_SIZE. That is, the receiving apparatus 200 may calculates a size of the signaling area of the frame based on the signaling information.

In FIG. 9, it is assumed that the size of the post-signaling information 23 is 5000 cells. Further, it is assumed that the number of P2 symbols 20 is two. Therefore, the size of the signaling information area including the pre-signaling information 21 and the post-signaling information 23 is calculated as 6840 cells by adding the 1840 cells and the 5000 cells. Since the P2 symbol 20 is two, the size of the signaling information 23 included in each of the P2 symbols 20 is 3420 cells (that is, 6840 cells/2=3420 cells). Therefore, a start location of the first PLP becomes a 3421^{st} cell. Therefore, when the start location of the first PLP is calculated, start locations of PLPs next to the first PLP may be calculated using data information included in the post-signaling information 23.

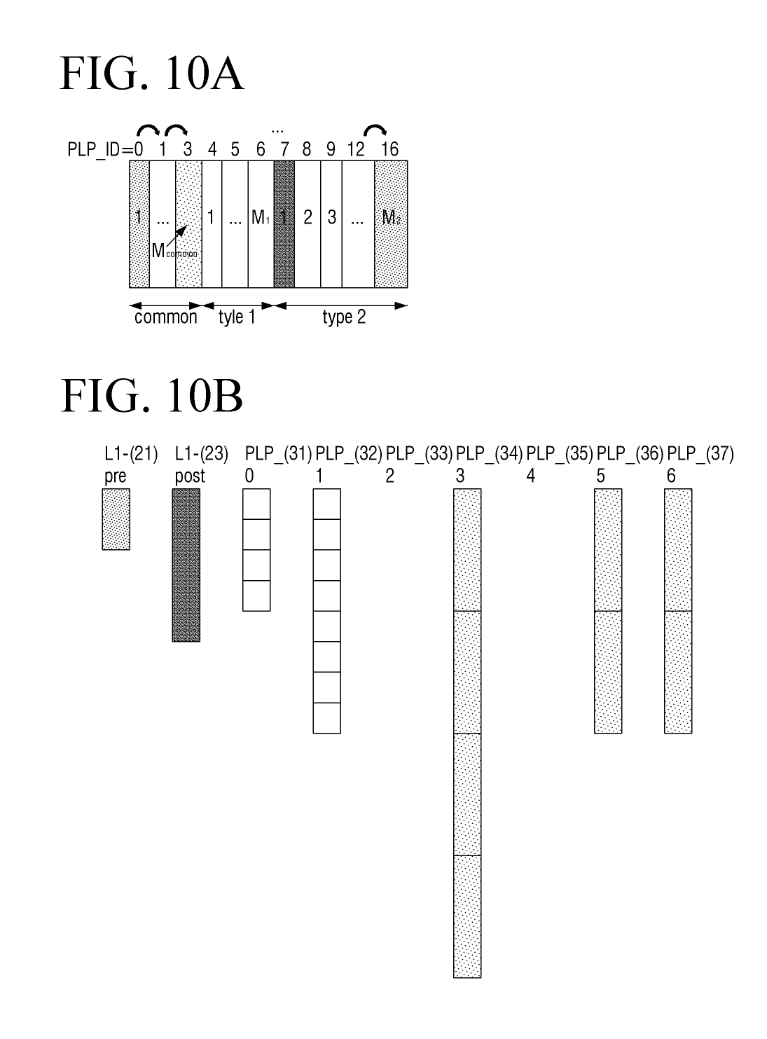

FIGS. 10A and 10B are views illustrating a process of calculating a start location of data mapped to a signal processing path according to an exemplary embodiment.

FIG. 10A illustrates a process of sequentially calculating start locations of PLPs using data ID information PLP_ID. In an embodiment, the PLPs include a common PLP, a first type PLP (Type 1 PLP), and a second type PLP (Type 2 PLP). Information which may be commonly transmitted through a plurality of PLPs is included in one PLP and transmitted, thereby increasing transmission efficiency. The PLP0 performs this function, and may be referred to as a common PLP. The first type PLP Type 1 PLP and the second type PLP Type 2 PLP are data PLPs used for data transmission. The first type PLP Type 1 PLP means a PLP having a form to be transmitted by one sub slice per one signal frame. The second type PLP Type 2 PLP means a PLP having a form to be transmitted by a plurality of sub slices.

The start locations of the PLPs are sequentially calculated using the data ID information PLP_ID. Even when a PLP which is not transmitted exists, the process of calculating the start location of the PLP is sequentially performed. For example, even when PLPs, that is, PLP0, PLP1, PLP3, PLP4, . . . are received, the data ID information PLP_ID calculates start locations of PLPs, that is, PLP0, PLP1, PLP2, PLP3, PLP4, . . . . At this time, the PLP2 is not received, and thus a size thereof becomes 0 (zero). As a result, this is the same as a case in which a start location of the PLP3 is calculated next to the PLP1.

As described above, the start locations of the second PLP or subsequent PLPs may be calculated based on information about an immediately previous PLP, which includes a start location PLP_ID_Start, data modulation information PLP_MOD, data FEC type information PLP_FEC_TYPE, and information about the number of data blocks PLP_NUM_BLOCKS of the immediately previous PLP.

That is, a start location of an n-th PLP may be calculated using Equation.

PLP_ID_Start_{—}n=PLP_ID_Start_{—}n−1+PLP_NUM_BLOCKS_{—}n−1×(PLP_FEC_TYPE_{—}n−1/PLP_MOD_{—}n−1). [Equation]

In an embodiment, when the process of calculating the start locations of the PLPs including the start location of the first PLP is implemented with software, the process may be implemented as follows.

```
      for i=0...N−1
      {
      if i == 0
      PLP_ID_Start_i = L1-Pre Cells + L1-Post Cells
else
      PLP_ID_Start_i =
PLP_ID_Start_i−1 + PLP_NUM_BLOCKS_i−1 ×
(PLP_FEC_TYPE_n−1 / PLP_MOD_n−1)
      }
```

FIG. 10B is a view illustrating a calculation result of the start location and size of a PLP through the above-described method. As a specific example, the process of calculating the start location and size of the PLP will be described. For example, it is assumed that the PLP received from the transmitting apparatus is PLP0, PLP1, PLP3, PLP5, and PLP6. As described in FIG. 9, it is assumed that the start location of PLP0 which is the first PLP is calculated as the 3421^{st}. Further, it is assumed that received signaling information is the same as Table 3.

TABLE 3

| PLP_ID | PLP_NUM_BLOCKS | PLP_FEC_TYPE | PLP_MOD |
|---|---|---|---|
| PLP0 | 4 | 16K | QPSK |
| PLP1 | 8 | 16K | 64QAM |
| PLP2 | 0 | — | — |
| PLP3 | 4 | 64K | 256QAM |
| PLP4 | 0 | — | — |
| PLP5 | 2 | 64K | 256QAM |
| PLP6 | 2 | 64K | 256QAM |

The data FEC type information PLP_FEC_TYPE and the data modulation information PLP_MOD are listed in Table 4.

TABLE 4

| Data FEC Type (PLP_FEC_TYPE) | Size |
|---|---|
| 16K LDPC | 16200 Bits |
| 64K LDPC | 64800 Bits |

TABLE 5

| Data Modulation (PLP_MOD) | Size |
|---|---|
| QPSK | 2 Bits |
| 16QAM | 4 Bits |
| 64QAM | 6 Bits |
| 256QAM | 8 Bits |

Therefore, the start locations of the PLPs are calculated as in Table 6.

TABLE 6

| PLP_ID | Calculation Process | PLP_ID_Start |
|---|---|---|
| PLP0 | (L1-pre cells + L1-post cells)/2 + 1 = | 3421 |
| | 6840/2 + 1 | |
| PLP1 | 3421 + 4 × (16200/2) | 35821 |
| PLP2 | 35821 + 8 × (16200/6) | 57421 |
| PLP3 | 57421 + 0 | 57421 |
| PLP4 | 57421 + 4 × (64800/8) | 89821 |
| PLP5 | 89821 + 0 | 89821 |
| PLP6 | 89821 + 2 × (64800/8) | 106021 |

Referring to FIG. 10B and Table 6, a size of the L1 pre-signaling information 21 is 1840 cells, and a size of the L1 post-signaling information 23 is 5000 cells, as illustrated in FIG. 9. Therefore, a start location of a PLP0 (31) becomes a 3421^{st} cell. A start location of a PLP1 (32) becomes a 35821^{st} cell, and a start location of a PLP2 (33) becomes a 57421^{st} cell. However, the PLP2 (33) is not received, and as a result, a start location of a PLP3 (34) becomes the 57421^{st} cell. A start location of a PLP4 (35) becomes an 89821^{st} cell, and a start location of a PLP5 (36) becomes the 89821^{st} cell since the PLP4 (35) is not received. Finally, a start location of a PLP6 (37) becomes a 106021^{st} cell, and a size of the PLP6 (37) may be calculated using the information for the number of data blocks PLP_NUM_BLOCKS of the PLP6, the data FEC type information PLP_FEC_TYPE, and the data modulation information PLP_MOD.

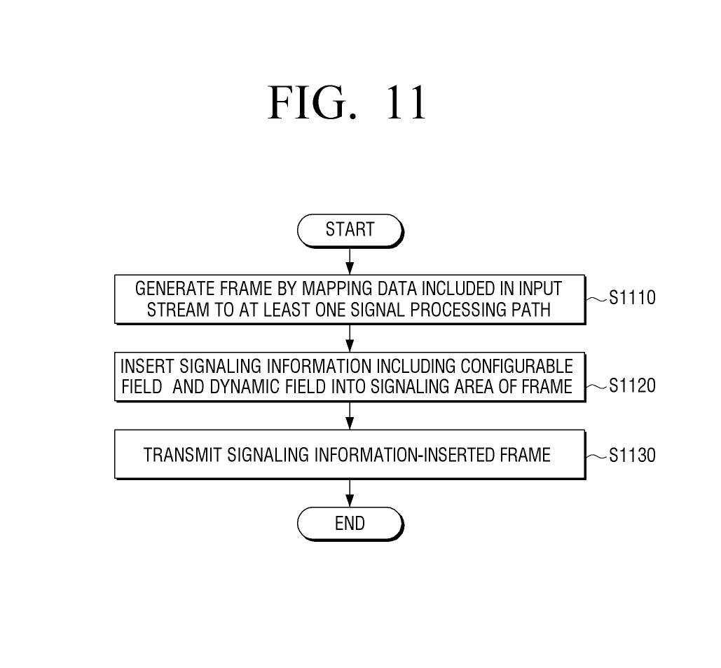

FIG. 11 is a flowchart illustrating a control method of a transmitting apparatus according to an exemplary embodiment.

Referring to FIG. 11, the transmitting apparatus generates a frame by mapping data included in an input stream to at least one signal processing path (S1110).

The transmitting apparatus inserts signaling information including a configurable field and a dynamic field into a signaling area of the frame (S1120). The dynamic field may selectively include only the information about the number of data blocks among information about the data mapped to the signal processing path. That is, the information about the number of data blocks may be included in any one of the configurable field and the dynamic field.

The signaling information includes pre-signaling information and post-signaling information. The post-signaling information includes the configurable field and the dynamic field.

The transmitting apparatus transmits the signaling information-inserted frame (S1130).

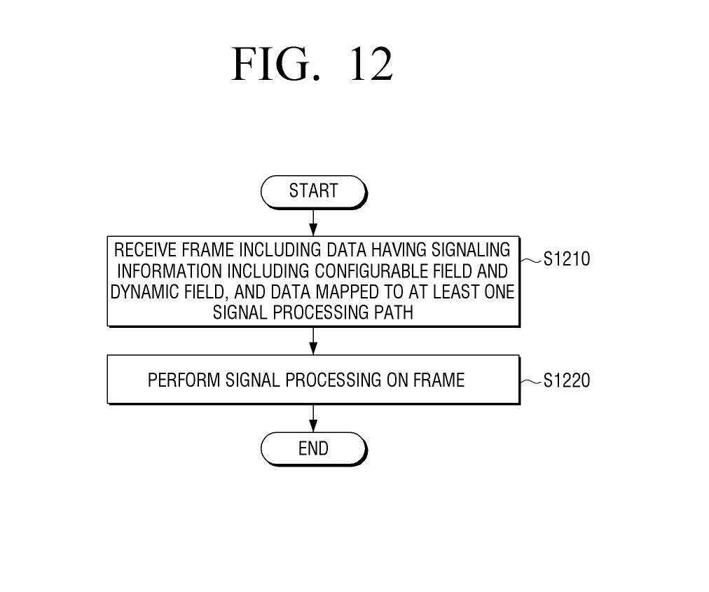

FIG. 12 is a flowchart illustrating a control method of a receiving apparatus according to an exemplary embodiment.

Referring to FIG. 12, the receiving apparatus receives a frame including the signaling information having the configurable field and the dynamic field, and data mapped to at least one signal processing path (S1210). The receiving apparatus receive a transmission frame according to a preset protocol with the transmitting apparatus.

The receiving apparatus performs signal processing on the received frame (S1220). The receiving apparatus may calculate a size of a signaling area of the frame based on the signaling information, and calculate a start location of data mapped to a first signal processing path among the data mapped to the at least one signal processing path based on a size of the calculated signaling area.

The receiving apparatus may calculate a start location of data mapped to an n-th signal processing path based on information about an (n−1)-th signal processing path among the at least one signal processing path. This information includes a start location, information about the number of data blocks, data modulation information, and data FEC type information of the data mapped to the (n−1)-th signal processing path. Further, the start location of the data may be sequentially calculated according to a data order using the data ID information PLP_ID.

The control method of a transmitting apparatus according to the above-described various exemplary embodiments may be implemented in a program and provided to the transmitting apparatus. The control method of a receiving apparatus may be implemented in a program and provided to the receiving apparatus.

In an example, a non-transitory apparatus-readable medium in which a program for performing generating a frame by mapping data included in an input stream to at least one signal processing path, inserting signaling information including a configurable field and a dynamic field into a signaling area of the frame, and transmitting the signaling information-inserted frame is stored may be provided to a transmitting apparatus.

A non-transitory computer-recordable medium in which a program for performing receiving a frame including signaling information having a configurable field and a dynamic field, and data mapped to at least one signal processing path, and performing signal processing on the frame is stored may be provided to the receiving apparatus.

The non-transitory computer-recordable medium is not a medium configured to temporarily store data such as a register, a cache, or a memory but an apparatus-readable medium configured to semi-permanently store data. Specifically, the above-described various applications or programs may be stored and provided in the non-transitory apparatus-readable medium such as a compact disc (CD), a digital versatile disc (DVD), a hard disc, a Blu-ray disc, a universal serial bus (USB), a memory card, a ROM, and the like.

At least one of the blocks or components illustrated in FIGS. 1, 2, 7 and 8 may represent a module, a program, or a part of code, which contains one or more executable instructions for performing specified logic functions. It should also be noted that the block diagrams in FIGS. 1, 2, 7 and 8 may be implemented by a dedicated hardware-based system for performing specified functions or operations, by a software-based system for performing specified functions or operations, or by a combination of dedicated hardware and computer instructions.

The foregoing exemplary embodiments and advantages are merely exemplary and are not to be construed as limiting the present inventive concept. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A transmitting apparatus, comprising:
a frame generator configured to generate a frame by mapping data included in an input stream to at least one signal processing path;
an information inserter configured to insert signaling information including a configurable field and a dynamic field into a signaling area of the frame; and
a transmitter configured to transmit the frame in which the signaling information is inserted,
wherein the dynamic field selectively includes only information about a number of data blocks among information about the data mapped to the at least one signal processing path.

2. The transmitting apparatus as claimed in claim 1, wherein the information about the number of data blocks is included in the configurable field or the dynamic field.

3. The transmitting apparatus as claimed in claim 1, wherein the signaling information includes pre-signaling information and post-signaling information, and
wherein the configurable field and the dynamic field are included in the post-signaling information.

4. The transmitting apparatus as claimed in claim 1, wherein the transmitting apparatus is implemented as a Digital Video Broadcasting the Second Generation Terrestrial (DVB-T2) transmission system, and
wherein the frame is implemented as a T2 frame.

5. A receiving apparatus, comprising:
a receiver configured to receive a frame which comprises data mapped to at least one signal processing path, and signaling information having a configurable field and a dynamic field; and
a signal processor configured to perform signal processing on the frame,
wherein the dynamic field selectively includes only information about a number of data blocks among information about the data mapped to the at least one signal processing path.

6. The receiving apparatus as claimed in claim 5, wherein the information about the number of data blocks is included in the configurable field or the dynamic field.

7. The receiving apparatus as claimed in claim 5, wherein the signaling information includes pre-signaling information and post-signaling information, and
wherein the configurable field and the dynamic field are included in the post-signaling information.

8. The receiving apparatus as claimed in claim 7, wherein the signal processor calculates a size of a signaling area of the frame based on the signaling information, and calculates a start location of data mapped to a first signal processing path among the data mapped to the at least one signal processing path based on the calculated size of the signaling area.

9. The receiving apparatus as claimed in claim 5, wherein the signal processor calculates a start location of data mapped to an n-th signal processing path based on information about data mapped to an (n−1)-th signal processing path among the at least one signal processing path, and
wherein the information about the data mapped to the (n−1)-th signal processing path comprises information about a number of data blocks, data modulation, and a data forward error correction (FEC) type of the data mapped to the (n−1)-th signal processing path.

10. The receiving apparatus as claimed in claim 5, wherein the configurable field includes identification (ID) information about the data mapped to the at least one signal processing path, data code rate information, data modulation information, and data forward error correction (FEC) type information.

11. A method of controlling a transmitting apparatus, the method comprising:
generating a frame by mapping data included in an input stream to at least one signal processing path;
inserting signaling information including a configurable field and a dynamic field into a signaling area of the frame; and
transmitting the frame in which the signaling information is inserted,
wherein the dynamic field selectively includes only information about a number of data blocks among information about the data mapped to the at least one signal processing path.

12. The method as claimed in claim 11, wherein the information about the number of data blocks is included in the configurable field or the dynamic field.

13. The method as claimed in claim 11, wherein the signaling information includes pre-signaling information and post-signaling information, and
wherein the configurable field and the dynamic field are included in the post-signaling information.

14. The method as claimed in claim 11, wherein the transmitting apparatus is implemented as a Digital Video Broadcasting the Second Generation Terrestrial (DVB-T2) transmission system, and
wherein the frame is implemented as a T2 frame.

15. A method of controlling a receiving apparatus, the method comprising:
receiving a frame which comprises data mapped to at least one signal processing path, and signaling information having a configurable field and a dynamic field; and
performing signal processing on the frame,
wherein the dynamic field selectively includes only information about a number of data blocks among information about the data mapped to the at least one signal processing path.

16. The method as claimed in claim 15, wherein the information about the number of data blocks is included in the configurable field or the dynamic field.

17. The method as claimed in claim 15, wherein the signaling information includes pre-signaling information and post-signaling information, and
wherein the configurable field and the dynamic field are included in the post-signaling information.

18. The method as claimed in claim 17, wherein the performing signal processing comprises calculating a size of a signaling area of the frame based on the signaling information, and calculating a start location of data mapped to a first signal processing path among the data mapped to the at least one signal processing path based on the calculated size of the signaling area.

19. The method as claimed in claim 15, wherein the performing signal processing comprises calculating a start location of data mapped to an n-th signal processing path based on information about data mapped to an (n−1)-th signal processing path among the at least one signal processing path, and
wherein the information about the data mapped to the (n−1)-th signal processing path comprises information about a number of data blocks, data modulation, and a data forward error correction (FEC) type of the data mapped to the (n−1)-th signal processing path.

20. The method as claimed in claim 15, wherein the configurable field includes identification (ID) information about the data mapped to the at least one signal processing path, data code rate information, data modulation information, and data forward error correction (FEC) type information.
